(19) United States
(12) Patent Application Publication
(10) Pub. No.: US 2009/0034476 A1
(43) Pub. Date: Feb. 5, 2009

(54) PACKET DATA CONVERGENCE PROTOCOL PROCEDURES

(75) Inventors: Peter S. Wang, E. Setauket, NY (US); Mohammed Sammour, Montreal (CA); Stephen E. Terry, Northport, NY (US); Jin Wang, Central Islip, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/183,182

(22) Filed: Jul. 31, 2008

Related U.S. Application Data
(60) Provisional application No. 60/953,639, filed on Aug. 2, 2007.

(51) Int. Cl. H04W 36/00; H04W 8/00

(52) U.S. Cl. 370/331; 370/310

(57) ABSTRACT

Method and an apparatus for activating a packet data convergence protocol (PDCP) reordering in a wireless transmit receive unit (WTRU) which receives a handover command message, resets a radio link control (RLC) entity of the WTRU, collects a PDCP sequence number (SN) and a range of the SN of out-of-sequence service data units (SDUs), reports the PDCP SN to a radio resource control (RRC) layer of the WTRU, transmits a handover confirm message along with a first unacknowledged PDCP SN uplink (UL), and activates the PDCP reordering based on the PDCP-SN-UL is disclosed. The WTRU includes PDCP entity including a control plane (C-plane) and a user plane (U-plane). Also, a robust header compression (RoHC) entity, a user ciphering entity, and an entity for the user plane data/control is also described.

### CROSS REFERENCE TO RELATED APPLICATIONS

This application claims the benefit of U.S. Provisional Application No. 60/953,639 filed on Aug. 2, 2007, which is incorporated by reference as if fully set forth.

### FIELD OF INVENTION

This application is related to wireless communications.

### BACKGROUND

A current goal of the third Generation Partnership Project (3GPP) long term evolution (LTE) is to develop new technology, new architecture, and new methods in LTE settings. Another goal is to specify configurations for providing improved spectral efficiency, reduced latency, and better utilization of the radio resources.

The LTE Packet Data Convergence Protocol (PDCP) is responsible for handling the inter-eNB handover (HO) PDCP service data unit (SDU) in-sequence (IS) delivery functionality. A method and an apparatus are defined to coordinate a wireless transmit receive unit (WTRU) PDCP and the Evolved Universal Terrestrial Radio Access Network (E-UTRAN) PDCP in eNB.

### SUMMARY

A method and an apparatus for activating a PDCP reordering in a WTRU receiving a handover command message, resetting a radio link control (RLC) entity of the WTRU, collecting a PDCP sequence number (SN) and a range of the SN of out-of-sequence SDUs, reporting the PDCP SN to a radio resource control (RRC) layer of the WTRU, transmitting a handover confirm message along with a first unacknowledged PDCP SN uplink (UL), and activating the PDCP reordering based on the PDCP-SN-UL is disclosed.

A WTRU including a processing device configured such that a PDCP entity processes a control plane data and a user plane data and the PDCP entity having a control plane (C-plane) entity that includes a PDCP sequence numbering entity, an integrity protection entity, and a control ciphering entity, and a user plane (U-plane) that includes a robust header compression (RoHC) entity, a user ciphering entity, and an entity for the user plane data/control, and wherein a format for a RoHC feedback PDU includes a header bit field, a type field, and RoHC feedback, wherein the header bit field indicates whether the RoHC feedback PDU is data or control is also described.

### BRIEF DESCRIPTION OF THE DRAWINGS

A more detailed understanding may be had from the following description, given by way of example in conjunction with the accompanying drawings wherein:

FIG. 1 is a functional block diagram of a wireless communication system in accordance with the disclosure;

FIG. 2 is a diagram of an uplink (UL) packet data convergence protocol (PDCP) packet reordering operation at inter-eNB handover;

FIG. 3 shows a wireless transmit receive unit (WTRU) determining the base PDCP sequence number (SN) for UL reordering;

FIG. 4 illustrates the WTRU deciding and transmitting PDCP Status for UL reordering;

FIG. 5 is a diagram of situating the PDCP reordering window, PDCP timer and its variables upon activation;

FIGS. 6A and 6B are a flow diagram showing reception of a downlink (DL) PDCP SDU after activation;

FIG. 7 is a detail version of a flow diagram showing reception of the DL PDCP SDU if the PDCP PDU is stored;

FIG. 8 shows a PDCP all packets processing architecture;

FIG. 9 shows a format of a control-plane (C-plane) PDCP protocol data unit (PDU);

FIG. 10 shows a format of a user-plane (U-place) PDCP PDU;

FIG. 11 shows the PDCP PDU second level definition and format of a control PDU; and

FIG. 12 shows a format of the PDCP U-plane non-data PDU when robust header compression (RoHC) feedback is on a separate channel.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

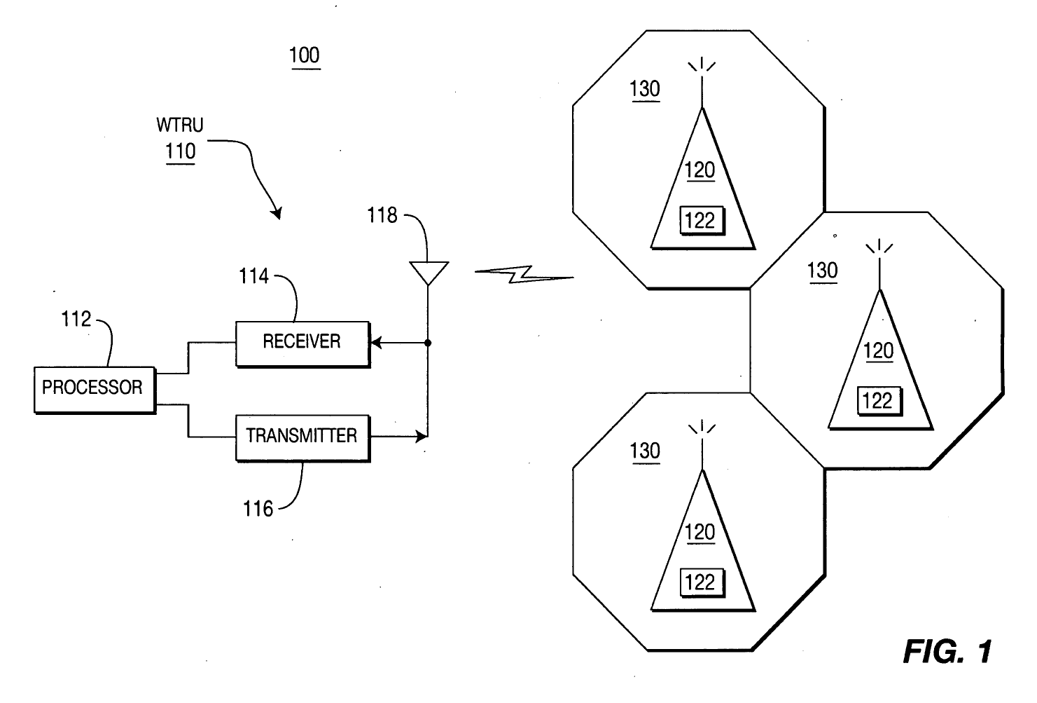

Referring to FIG. 1, a wireless communication network 100 comprises a WTRU 110, one or more Node-Bs 120, and one or more cells 130. Each eNB 120 comprises in general one cell 130. The WTRU 110 comprises a processor 112 configured to implement a PDCP reordering method. The Node-B 120 comprises a processor 122 configured to implement a PDCP reordering method.

As will be used herein, a wireless communication system may include a plurality of WTRUs, base stations, and radio network controllers (RNCs). The WTRUs may be in communication with the base stations, which are in communication with a Service Access Gateway (SA GW). It should be noted that any combination of wireless and wired devices may be included in the wireless communication system. The WTRU is in communication with the base station and they both are configured to perform a method for the PDCP operation.

In addition to the components that may be found in a typical WTRU, the WTRU includes a processor 112, a receiver 114, a transmitter 116, and an antenna 118. The processor is configured to perform the PDCP operations. The receiver 114 and the transmitter 116 are in communication with the processor 112. The antenna 118 is in communication with both the receiver 114 and the transmitter 116 to facilitate the transmission and reception of wireless data.

In addition to the components that may be found in a typical base station, the base station 120, similar to the WTRU 110, includes a processor 122, a receiver, a transmitter, and an antenna (not shown in FIG. 1). The processor is configured to perform the PDCP operations. The receiver and the transmitter are in communication with the processor 122. The antenna is in communication with both the receiver and the transmitter to facilitate the transmission and reception of wireless data.

There are three different embodiments for configuring and activating the UL PDCP reordering before inter-eNB handover.

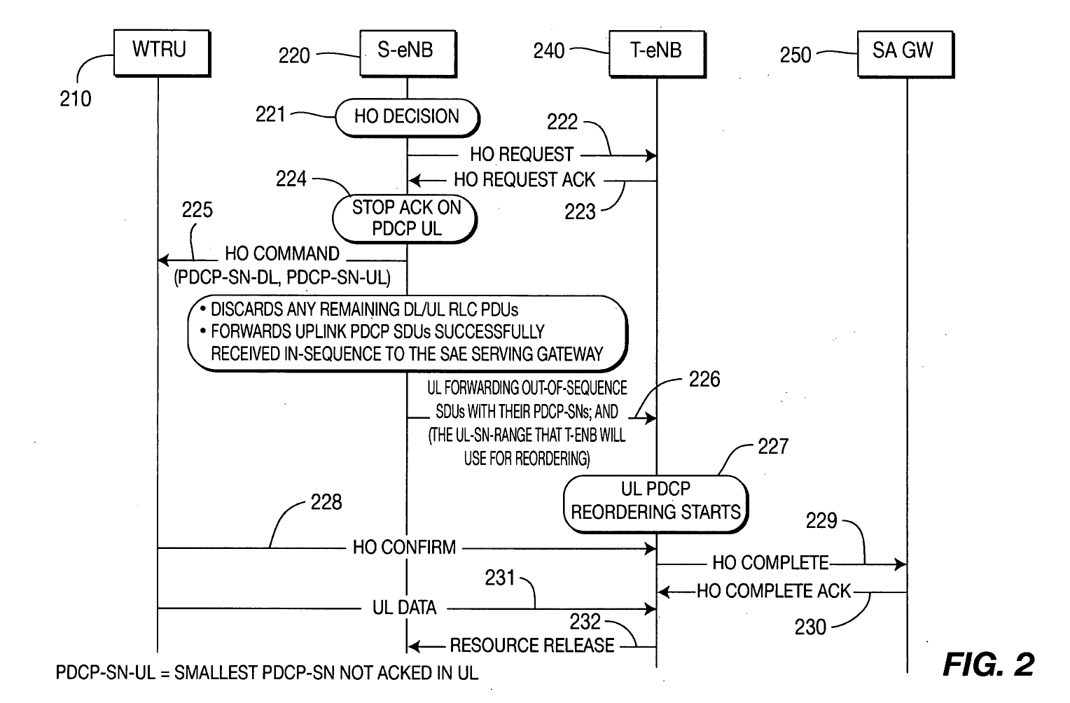

In a first embodiment, referring to FIG. 2, a source eNB (S-eNB) 220 determines a base PDCP SN for UL reordering. When the S-eNB 220 decides to initiate handover 221, the S-eNB 220 queries a target eNB (T-eNB) 240 via a HO request message 222 and receives back from the T-eNB 240 a HO Request acknowledgement (ACK) 223. The S-eNB 220 then withholds sending ACK 224 of Radio Link Control (RLC) status or PDCP status on an entire or a segment of a received PDCP SDU UL to obtain the reordering base PDCP SN in uplink direction.

The S-eNB 220 then transmits the RRC message HO Command 225 to the WTRU 210, notifying the WTRU 210 with the first unacknowledged PDCP-SN-UL in the UL (i.e., the WTRU 210 may discard the acknowledged PDCP SDUs at this point).

The S-eNB forwards the out-of-sequence UL PDCP SDUs 226 with their PDCP SNs and also the first unacknowledged PDCP-SN-UL and, possibly the last unacknowledged PDCP-SN-UL or the reordering range. The first and the last SNs approximately indicate the reordering range to the T-eNB 240. The T-eNB 240 then activates reordering function 227 of the UL PDCP with the base PDCP SN and the reordering range.

The WTRU 210 transmits the HO Confirm message 228 activating PDCP reordering of the T-eNB 240. Alternatively, the UL PDCP reordering function may be activated at this stage if not activated as of yet. At this point, the T-eNB 240 sends HO Complete 229 command to a Service Access Gateway (SA GW) 250. The SA GW 250 sends HO Complete ACK 230 back to the T-eNB 240. The WTRU 210 then sends the UL data 231 to the T-eNB 240, which in return releases the resources 232 to the S-eNB 220.

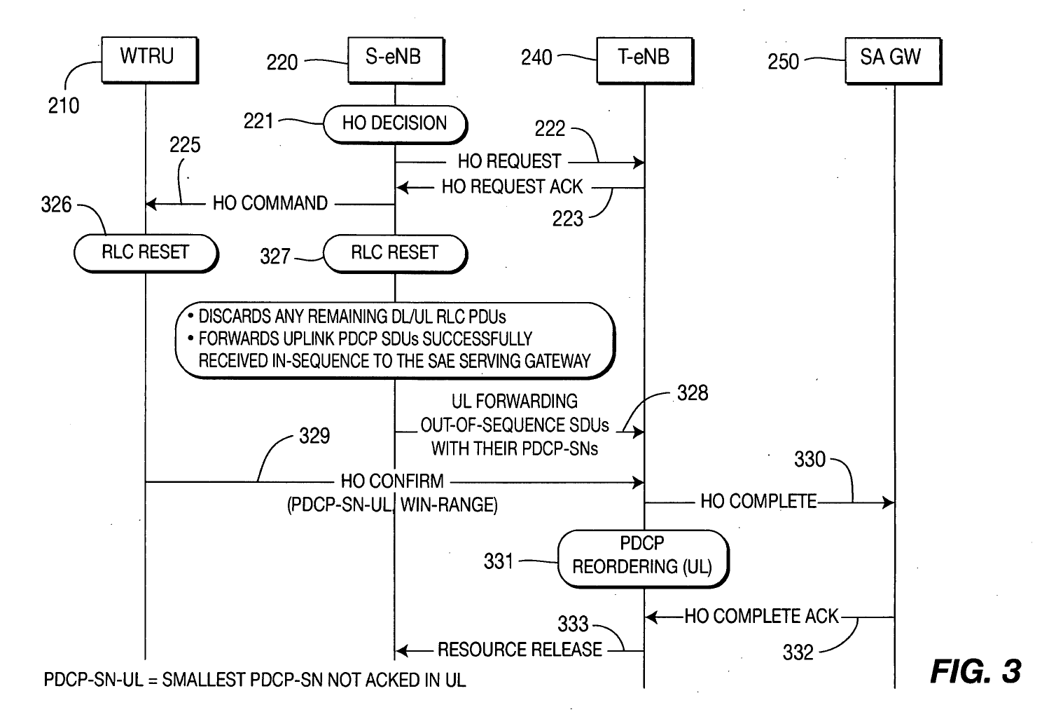

In a second embodiment, the WTRU 210 decides the base PDCP SN for UL PDCP reordering and transmits the PDCP SN via HO Confirm. FIG. 3 illustrates this embodiment showing the UL PDCP reordering configuration and activation.

The second embodiment captures similar elements as those of the first embodiments until the WTRU 210 receives the HO Command 225. Therefore, the similar portions are not repeated here but incorporated by reference. Referring to FIG. 3, when the WTRU 210 has received the HO Command 225 from the S-eNB 220, as described in the first embodiment, the WTRU 210 resets its RLC entity 326. The WTRU 210 collects the base PDCP-SN-UL (i.e., first unacknowledged RLC SDU equivalent PDCP SN) and the SN range of other out-of-sequence SDUs. The WTRU 210 then provides them to its RRC layer. The WTRU's RLC reset or re-establishment 326 may be triggered such as the WTRU reception of the HO Command 225; the reception of a flag within the HO Command (for example, within an RRC connection change command); autonomously may be triggered within the WTRU (for example, triggered by switch of physical reception to the T-eNB); or, triggered via any other event.

The S-eNB 220 then resets RLC operation 327 and forwards all out-of-sequence but successfully received PDCP SDUs with their PDCP SNs 328 to the T-eNB 240. The out-of-sequence uplink PDCP SDUs are stored at the T-eNB 240 until they are processed by the PDCP reordering 331 or 411. Resetting the RLC 327 of the S-eNB 220 may be delayed to allow for handover failure recovery at the S-eNB.

The WTRU 210 sends the HO Confirm message 329 with the first unacknowledged PDCP-SN-UL and possibly the reordering range or the last unacknowledged PDCP-SN-UL to the T-eNB 240. The first and the last SNs include the reordering range. The T-eNB 240 sends HO Complete 330 command to the SA GW 250. The T-eNB 240 then activates the T-eNB PDCP reordering 331 with the PDCP-SN-UL and optionally, the window range, passed in the HO Confirm message 329. The SA GW 250 sends HO Complete ACK 332 back to the T-eNB 240, which in turn releases the resources 333 to the S-eNB 220.

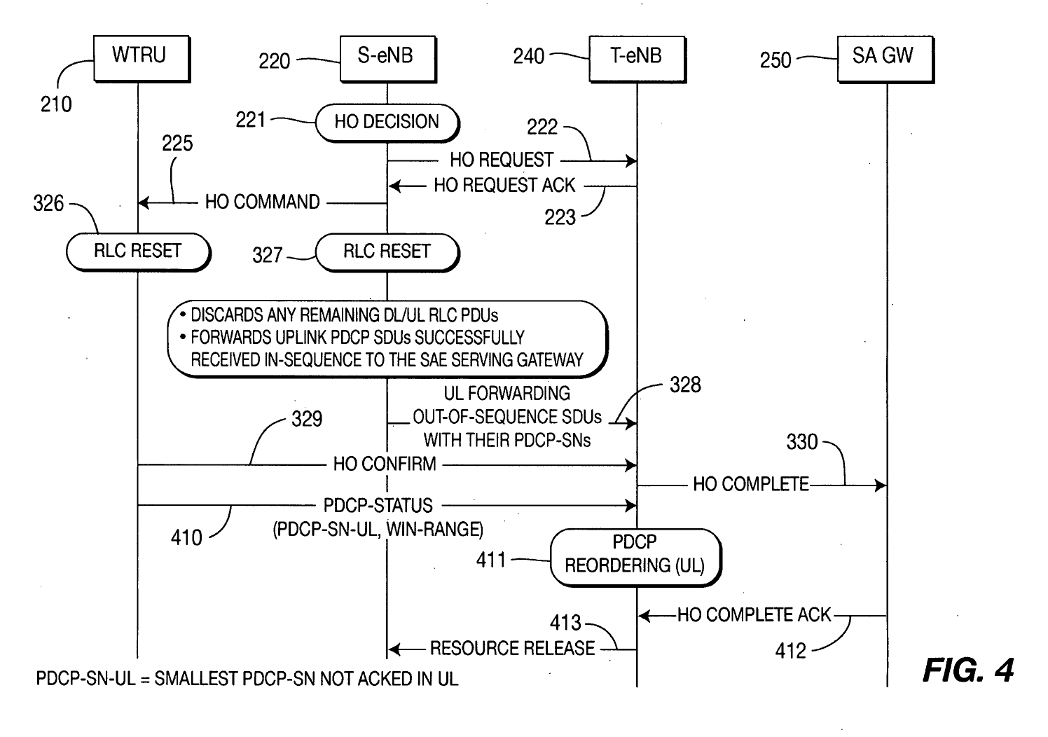

In a third embodiment, similar to the second embodiment, the WTRU 210 decides and sends PDCP Status for UL PDCP reordering, as illustrated in FIG. 4. The third embodiment captures similar elements as those of the second embodiments until the HO complete 330 is sent to the SA GW 250. Therefore, the similar portions are not repeated here but incorporated by reference. Referring to FIG. 4, when the T-eNB 240 sends a HO Complete 330 command to the SA GW 250 and the WTRU 210 sends an HO Confirm 329 message to the T-eNB 240 as the response to the HO command from the S-eNB 220, the WTRU 210 sends the PDCP Status message 410 along with the base PDCP SN to the T-eNB 240. The PDCP Status message 410 preferably also includes the reordering range, approximately the out-of-sequence PDCP SDUs (i.e., unacknowledged) to the T-eNB 240 for explicit activation of the UL PDCP reordering 411. The SA GW 250 sends HO Complete ACK 412 back to the T-eNB 240, which in turn releases the resources 413 to the S-eNB 220.

The WTRU PDCP downlink (DL) reordering function during inter-eNB handover is now described. Although this is specified for the DL PDCP reordering, the principles may also be applied to the UL PDCP reordering in an eNB during the handover.

The DL IS delivery during inter-eNB handover is based on a continuous PDCP SN and is provided by the reordering function at the PDCP layer, which may be activated at least during inter-eNB mobility handover.

Other events such as an RLC reset or RLC reestablishment or an RLC out-of-sequence delivery during the WTRU connected state operations may also require PDCP reordering. Reordering is performed when the RLC fails to properly perform IS delivery to the PDCP activation of the PDCP. For example any case of an RLC reset or re-establishment or an RLC move receive window procedure may invoke PDCP reordering.

During handover, the WTRU's RLC reset or re-establishment 326 may be triggered such as the WTRU reception of the HO Command 225; the reception of a flag within the HO Command (for example, within an RRC connection change command); autonomously may be triggered within the WTRU (for example, triggered by switch of physical reception to the T-eNB); or, triggered via any other event.

The following are examples of activation triggers for the WTRU PDCP reordering function for the DL:

Activation from the RRC layer by the reception of the RRC handover command message in which the S-eNB sends the WTRU first expected-PDCP-SN for the reordering and IS delivery.

Activation from the RRC layer by the reception of the RRC handover command message, or by the reception of the RRC handover command message that contains a flag. For example, a flag within an RRC connection change command, or within anywhere else, whereby the flag is used to indicate any one or more of the following: activate PDCP reordering, RLC reset or re-establishment of RLC and MAC, layer 2 reset or layer 2 reestablish, or deactivate RLC reordering.

Activation from the RLC layer upon reset, reestablishment, out-of-sequence, certain WTRU RLC error handling with the indication of the first expected-PDCP-SN for subsequent reordering or IS delivery.

Activation from the RLC layer indicating the last IS, or first out-of-sequence RLC protocol data unit (PDU) or RLC SDU delivered to the PDCP layer.

One deactivation trigger for the WTRU PDCP reordering function is completion of IS delivery for all of the SDUs in the reordering window range. The reordering window range is a parameter from the HO Command or derived from the last expected-PDCP-SN from the HO Command or from a pre-defined or pre-configured reordering range parameter for RLC related IS delivery.

Another deactivation trigger is a reception of the SDU with a specified PDCP SN, wherein the last expected-PDCP-SN is from the HO Command message or derived from the following:

first expected-PDCP-SN+window range,

or

first expected-PDCP-SN+window range−1.

Other deactivation triggers include receipt of a HO Confirm message sent from the RRC. The T-eNB 240 starts the DL PDCP traffic when it sees the WTRU HO Confirm message 228, 329 or, a receipt of a message from RLC when the RLC reset, the RLC reestablishment, or the RLC out-of-sequence situation is complete. One option is to indicate in RLC signaling the start of the SDU IS delivery and RLC reset or re-establishment or any other RLC event resulting in loss of the SDU IS operation.

The WTRU PDCP reordering function is invoked by the PDCP entity on an LTE radio bearer (RB). The PDCP reordering window, timer, and variables are now described in detail.

The PDCP reordering window is defined as a function of [next-expected-IS-SN, leading-win-edge], where the packets in the window are ordered with a low number (i.e., next-expected-IS-SN) and a high number (i.e., leading-win-edge). The variable next-expected-IS-SN is the next expected IS SN, which indicates the next expected SDU PDCP SN. The variable leading-win-edge indicates the leading reordering window edge. And, the variable max-missing-SN-wait-time indicates a stale-prevention timer value. The next-expected-IS-SN may be either explicitly signaled by the transmitter or is derived internally by an indication of the last IS RLC delivered SDU.

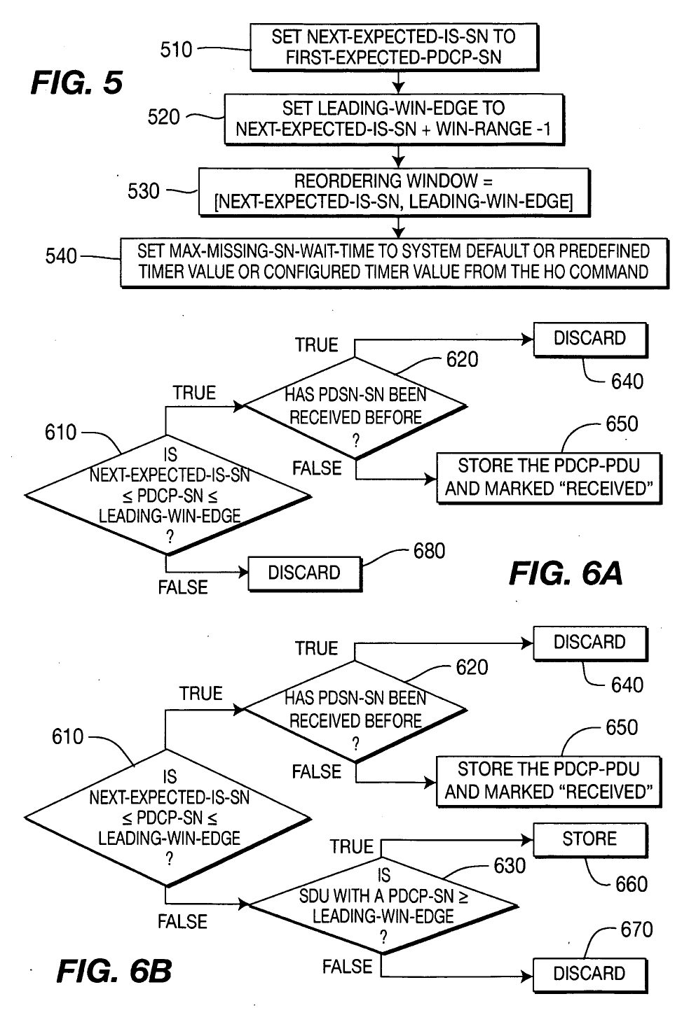

FIG. 5 illustrates an initialization upon activation by setting up the reordering window and timer related to the variables defined. The next-expected-IS-SN variable is set to the input first-expected-PDCP-SN 510. Setting the leading-win-edge variable to the next-expected-IS-SN+win-range−1 or to the last-PDCP-SN or other equivalent variable from the WTRU RLC triggered activation 520. As a result, reordering window is now a function of [next-expected-IS-SN, leading-win-edge] 530.

The max-missing-SN-wait-time variable is set to either a system default or predefined timer value per RB; or, a configured timer value from the HO Command or the PDCP Status message 540. The max-missing-SN-wait-time variable may optionally be depended on the underlying RLC mode, (i.e. for RLC acknowledge mode (RLC-AM)). Because there is an ARQ mechanism for guaranteed delivery, the stale-prevention timer in the PDCP reordering may not be needed. If it is depended on an RLC unconfirmed mode (RLC-UM), then the stale-prevention timer needs to be set.

If the RLC mode is RLC-AM, then the max-missing-SN-wait-time variable is set to infinity to not use the wait time. In this case, the RLC-AM notifies the PDCP reordering function when there is a timeout on the RLC SDU reception. When the max-missing-SN-wait-time variable is set, all of the SN positions including the end positions of the reordering window are marked as “un-received”.

Once initialization has occurred, as described with respect to the FIG. 5, reception of a DL PDCP SDU after activation occurs.

FIG. 6A and FIG. 6B illustrate the reception of the DL PDCP SDU. If the PDCP SN associated with the SDU is within the reordering window (i.e. next-expected-IS-SN≦PDCP SN≦leading-win-edge) 610 with modulo comparison and, if a determination of whether the PDCP SN has been received before 620 it is conducted (not marked as “un-received”), the PDCP SN is a duplicate and the PDCP SN is discarded 640. If the PDCP SN has not been received before, then the PDCP PDU is stored and marked “received” for the SN position 650. The conditions as described in 620 and 650 apply when the duplicate detection functionality is together with the reordering function. Otherwise, if duplicate detection is architecturally positioned below reordering then this does not apply.

If the condition 610 (i.e. the received PDCP-SN for the SDU is outside the reordering-window) is not true then, the HO activated reordering function operates within reordering window, and does not allow SDUs outside the window in any way, hence, the PDCP SN is discarded 680 (i.e., this is shown in FIG. 6A). Alternatively, if the condition 610 is not true then, it is determined if the SDU with the PDCP SN is ≧leading-win-edge 630. If this holds true then the PDCP SN is stored 660, and the reordering window is not moved. Otherwise it is discarded 670 (i.e., this is shown in FIG. 6B).

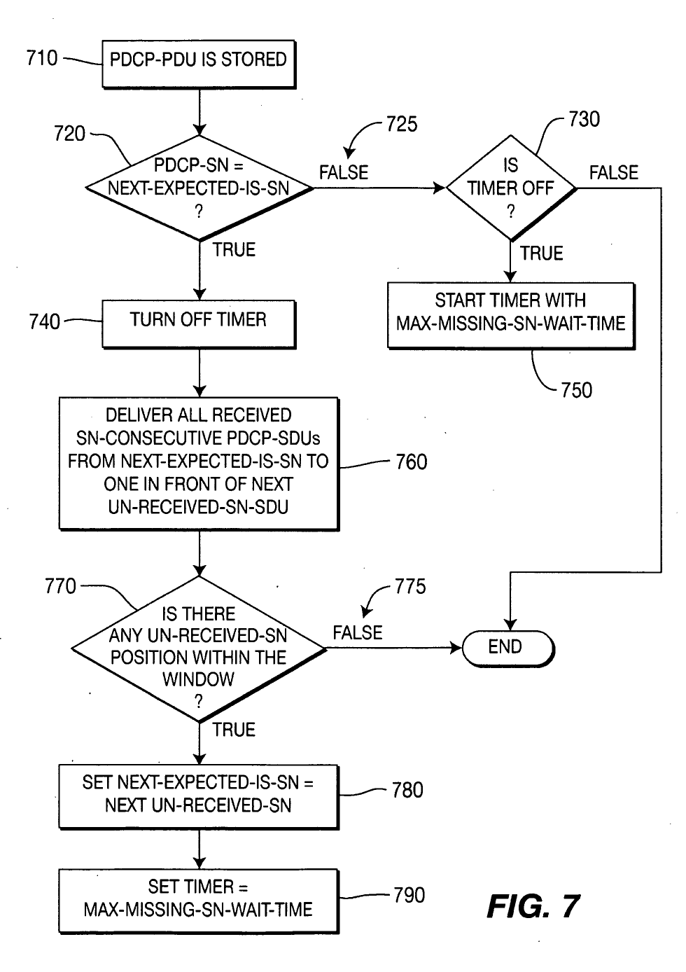

FIG. 7 shows a flow diagram of the events when the PDCP PDU is stored 710 during the reception of the DL PDCP SDU (see FIGS. 6A and 6B). It is determined if the PDCP SN is the next-expected-IS-SN 720. If it is, then the timer is turned OFF 740. All received SN-consecutive PDCP SDUs are delivered from the current next-expected-IS-SN, including those with SN on the leading side of the next-expected-IS-SN, up to the one in front of the next un-received-SN SDU within the window, to the upper layer 760.

If there is any un-received-SN position within the window 770, the next-expected-IS-SN is set to the next un-received-SN 780; and the timer is started at the max-missing-SN-wait-time 790. If all of the SDUs with SNs within the window including the leading-win-edge are received or delivered 775, the PDCP reordering function is stopped.

If the PDCP SN is not equal to the next-expected-IS-SN 725 (i.e., it is exceeded and has created a gap in the SN) and, if the timer is OFF 730, the timer is started with the value in max-missing-SN-wait-time 750 or at infinite or at some value depending on the RLC mode, RLC AM or RLC UM.

In the case where the stale-prevention timer times out, or if the max-missing-SN-wait-time is infinity for RLC AM and an RLC indication of AM timer times out on an RLC SDU SN and the RLC SDU SN is the next-expected-IS-SN, then the SN position pointed to the next-expected-IS-SN is marked as “timed-out”. And, all received SN-consecutive PDCP SDUs are delivered from the current next-expected-IS-SN+1, including those with the SN on the leading side of the next-expected-IS-SN up to the one preceding the next un-received-SN SDU within the window to the upper layer.

If the RLC SN is not equal to the next-expected-IS-SN, the SN position is marked by the RLC PDU SN as “timed out.” If there are un-received SDUs in the window, the timer is started at the max-missing-SN-wait-time and the next-expected-IS-SN is pointed to the first un-received SDUs in the window.

The PDCP reordering function is deactivated when all of the PDCP PDUs within the window are not marked as “un-received” and delivered either by a receiving PDCP SDU or by timer timeout. Or, the PDCP reordering function is deactivated when the updated next-expected-IS-SN is equal to (or greater than) the leading-win-edge. Or, the SDU with the PDCP SN equal to the last-expected-PDCP-SN has been received. Or, the PDCP reordering function is deactivated if the internal RLC reset or RLC re-establishment or RRC HO Complete generates a PDCP reordering function complete signal to the PDCP for the relevant RB/logical channel. The method for generating the complete signal is to have an indication of the first IS RLC SDU following the RLC reset or RLC reestablishment. The reordering at this point ends and all of the SDUs are delivered to its upper layers.

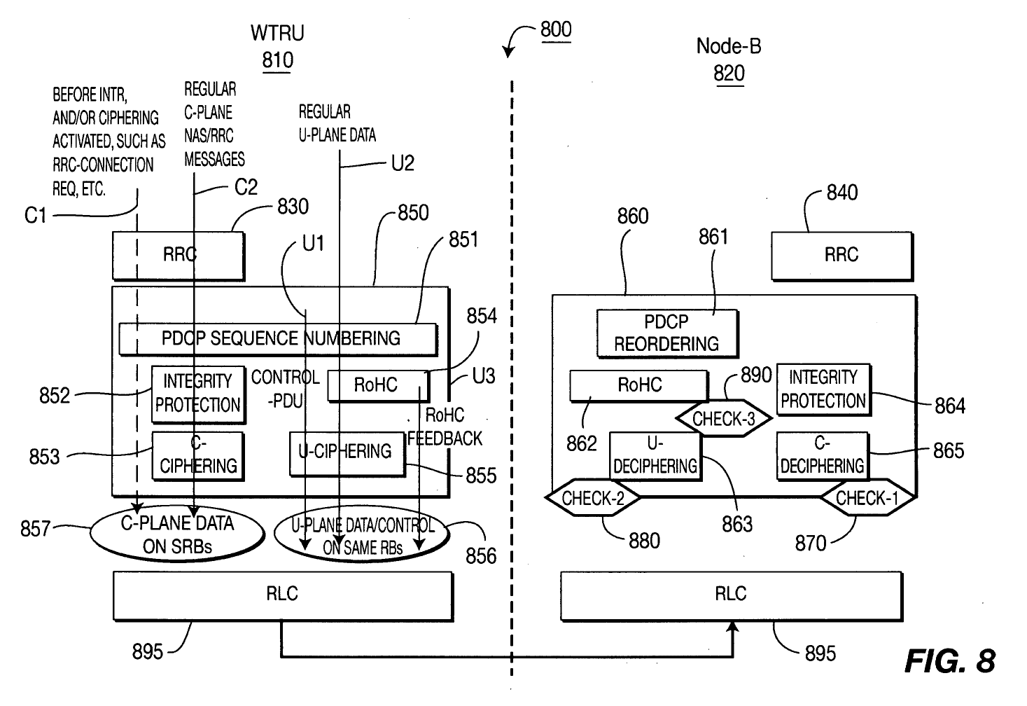

FIG. 8 illustrates a PDCP processing architecture. In accordance with an embodiment of this application, the following PDCP packet types may be seen.

Control-Plane (C-Plane) Packets

There are four possible categories of PDCP C-plane packets. If separate integrity-protection and ciphering are not allowed, then only category 1 and category 4 apply. Otherwise, all four are applicable.

1. The RRC messages that are neither ciphered nor integrity protected before the authentication and the security protection is activated, such as the RRC-Connection-Request (i.e., certain WTRU identity may be protected); or Non Access Stratum (NAS) messages that are already security protected at a NAS level and therefore, level protection for the PDCP is not needed;

2. RRC or NAS messages with integrity protected at the PDCP level;

3. RRC or NAS messages with ciphered at the PDCP level; and

4. RRC or NAS messages both ciphered and integrity protected at the PDCP level.

The C-plane messages are transmitted and received over signaling radio bearers (SRBs), and are preferably not mixed with user plane (U-plane) data packets (to be disclosed hereinafter) and are not subject to header compression.

Referring to FIG. 8, detail version of the PDCP processing architecture 800 is described. The diagram analyzes different processing on the messages or packets flowing from the WTRU 810 to the Node-B 820 to define the PDCP data PDU header formats. Messages and/or packets are originated at the WTRU 810. The messages and/or packets received at the Node-B 820 are processed according to the encoded data headers.

The RRC 830 transmits requests to the RRC 840 starting the network access or sends command responses. The RRC 840 sends commands to the RRC 830 instructing the WTRU 810 to perform predefined tasks and pass the configuration and controls to the PDCP 850 or the RLC 895. The PDCP 850 and 860 include C-plane and U-plane traffic.

Within the PDCP 850 there include PDCP sequence numbering 851, which is responsible to generate a unique PDCP SN to place into the message or the packet header to sequence the message or the packets. The SN is also used in the subsequent integrity protection and/or ciphering processes. The integrity protection 852 and the C-ciphering 853 represent their respective functions to the passing messages. The dotted line C1 neither has integrity-protection nor has ciphering applied to it. The line C2 which carries regular C-plane NAS or RRC messages has either integrity protection or ciphering or both applied. The C-plane data on SRBs 857 is a multiplexing function that put the C-plane data flows together on same SRBs.

The PDCP 850 also includes RoHC 854, which is an IP header compression function that reduces the data volume. The U-ciphering 855 is for user plane data ciphering that enhances data security. The U-plane Data/Control on the same RBs 856 is a multiplexing function that places the U-plane data flows and certain peer-to-peer control packets together onto a same RB. The line RoHC feedback packets U3 has neither RoHC nor ciphering applied to it. The regular U-plane Data U2 has both RoHC and ciphering applied. And, the Control-PDU line U1 has ciphering applied.

The PDCP headers have the provisioning for indicating which of the described functions have applied to the messages or to the packets, so that a corresponding de-processing may be applied on the receiving end to restore the message or the packets to its original form.

The Check-1 870, Check-2 880, and Check-3 890 determine the encoding of the header and decide the kind of de-processing that may be applied. They also determine the type of functionality that may perform the de-processing. The Check-1 870 detects line C1 and line C2 to determine if integrity protection or ciphering has been applied to the received messages or packets. If applied, the message or packets are forwarded to the de-cipher 863, 865 or the integrity-protection 864. If not, it passes through the PDCP and forwards it to the RLC 895 directly.

The Check-2 880 determines if the packets from line U1, line U2 or line U3 have been ciphered. If they are, then it passes the packets for U-decipher 863. The Check-3 890 determines whether the message or the packet is a PDCP-control-PDU U1 which bypasses the RoHC 862 but directly to the PDCP control. Or, if it is a regular U2 which needs RoHC to perform a de-compression or a RoHC feedback packet, which goes to RoHC, a feedback packet. The PDCP reordering function 861 on the Node-B 820 is functioning when an inter-eNB handover occurs.

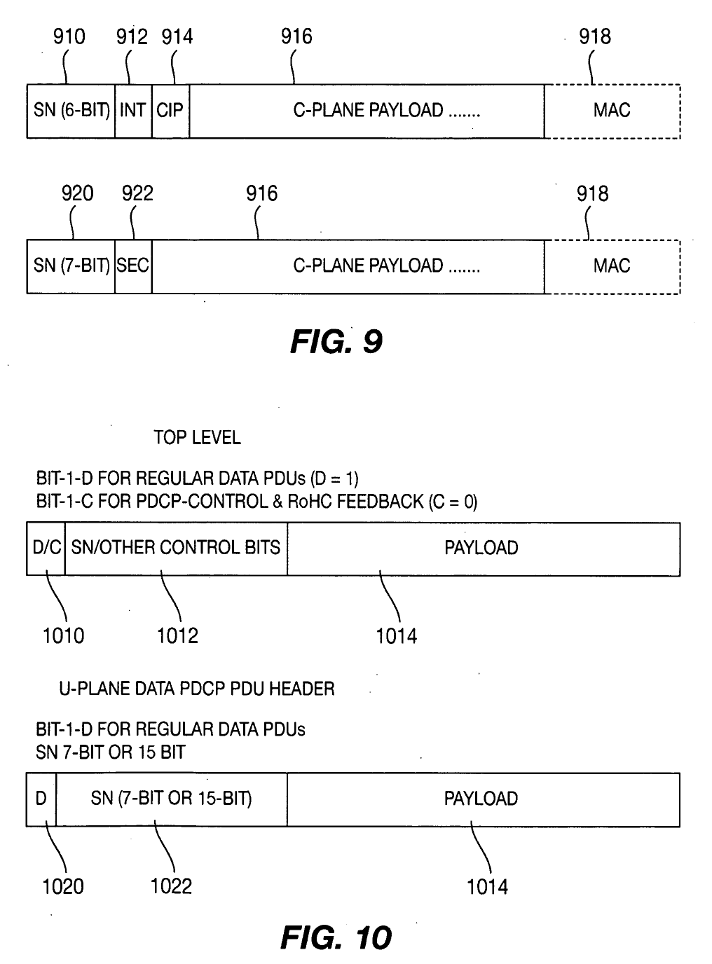

FIG. 9 shows a C-plane PDCP PDU format in either one of the two formats. The selected target depends on whether the above category 2 and category 3 of the PDCP C-plane packets are allowed. If category 2 and category 3 are not allowed, then the SN 7-bit format 920 is used at “check-1” in FIG. 8.

The first SN 6-bit format 910 has two 1-bit flags. The flag for integrity protection (INT) 912 and flag for ciphering (CIP) 914 indicate whether the integrity protection and the ciphering are separately applied (bit set). The second SN 7-bit format 920 has one 1-bit flag. The flag security protection (SEC) 922 indicates whether both integrity protection and ciphering have to be applied simultaneously. The C-plane PDCP PDU formats include C-plane payload 916 and potentially medium access control (MAC) information 918.

PDCP U-Plane Packets or PDCP U-Plane PDUs

For the U-plane PDCP packets, there are three categories.

1. Regular U-plane data Internet Protocol (IP) packets, which are preferably header compressed and ciphered, and therefore, the associated PDCP SN is mandatory;

2. Robust Header Compression (RoHC) feedback packets, which do not require ciphering and with no PDCP SN; or

3. PDCP-Control-PDU such as PDCP-STATUS, which is generated by the PDCP U-plane entity for in-band signaling or PDCP control and definitely does not require header compression. This category may or may not need to be ciphered and in the latter case, which is preferred, no SN is needed since no reordering is required in any case.

Since the three types of PDCP packets or PDUs are transmitted and received over the same RB and PDCP entity, the checking processing “Check-2” 880 and “Check-3” 890 in the receiving entity, illustrated in FIG. 8, (right hand side) may apply. At “Check-2” 880, the PDCP distinguishes the incoming PDUs by determining whether deciphering needs to be performed (category 1 packets vs. category 2 packets). Or, at “Check-3” 890 the PDCP decides whether a PDU goes to the RoHC function (category 2 of RoHC feedback or category 1 of regular data) or goes to the PDCP control unit (category 3 of a Control PDU) function (not shown in FIG. 8).

Therefore, fields for discrimination for processing in the PDCP PDU header for U-plane PDUs are desired.

FIG. 10 illustrates U-plane PDCP PDU format bit-1 definition and pure data PDU. For the U-plane PDCP PDUs, the header first bit field, “D/C” field 1010, first separates the pure data PDU (i.e., D=1) from other two packets for non data purposes (i.e., C=0) or for control purposes. If the first bit field is D then the second bit field represents SN 1022. If the first bit field is C, then the second bit field is other control bits 1012. The U-plane PDCP Data PDU comprises the PDCP SN for possible 7-bit or 15-bit or another number of bits 1022. The first bit field is D 1020, in which case the second bit field is SN 1022. The payload 1014 is a pure user level data that uses a packet space other than the header part the packet carried.

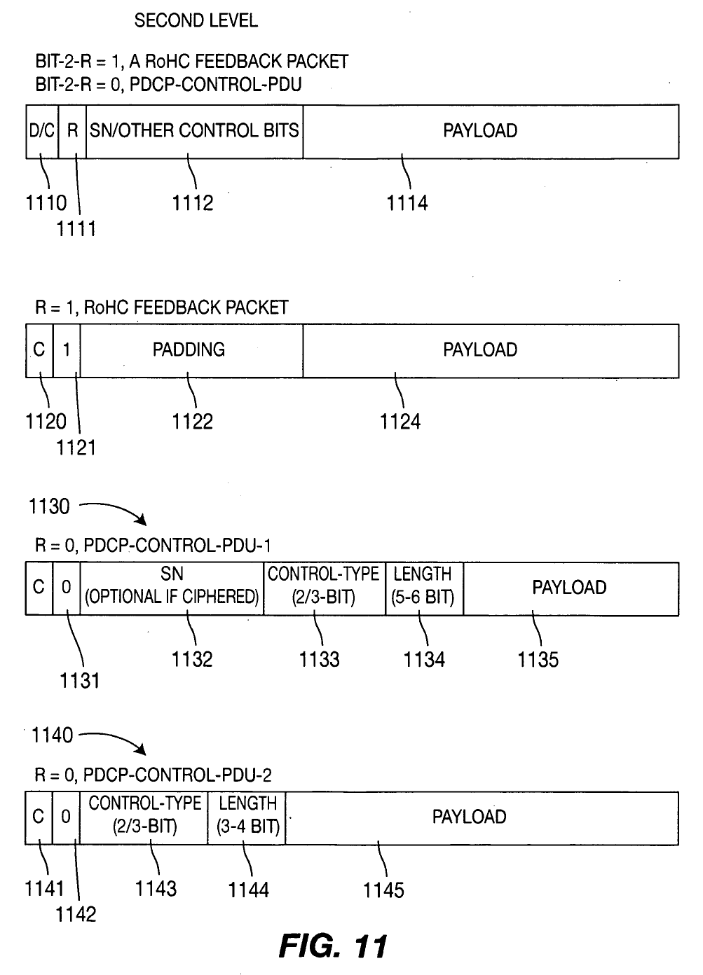

For the PDCP-Control-PDU and the RoHC feedback packets, a further bit is needed to distinguish the C-plane and U-plane formats. The format is defined as illustrated in FIG. 11.

The first bit 1110 is same as that of FIG. 10. Referring to FIG. 11, a second bit in the U-plane PDCP-Control-PDUs is defined as an R-bit 1111 to distinguish the PDCP-Control-PDU (i.e., R=0) (1131) from the RoHC feedback packet (i.e., R=1) 1121, indicating whether the RoHC function is involved.

For the RoHC feedback packets or PDU, since it is not subject to ciphering and other PDCP operations of the sequential control nature, it does not need SN field. The SN/other control bit field 1112 and the payload fields 1114, 1124, 1135, and 1145 are the same as the one described above in FIG. 10. The remaining header byte may be just padding (1122) if octet alignment is required.

For the PDCP-Control-PDU, there are several format possibilities.

PDCP-Control-PDU-1 format 1130: when R has a value of zero 1131, the SN field is used for numbering the control-PDU for ciphering purpose. The C field is as same as 1120 and 1141. The SN number 1132 here may be in a separate domain space (therefore shorter) than the Data PDUs. The control-type field 1133 is used to distinguish possible different types (e.g., PDCP-STATUS vs. PDCP-RESET, etc.) of control PDUs, and the length-indicator field 1134 indicates the payload or message length in octets.

PDCP-Control-PDU-2 format 1140: when R has a value of zero 1142, no ciphering on the PDCP-Control-PDU is assumed and therefore no SN field is needed. The control-type 1143 and the length-indicator fields 1144 may fit together with the “D/C” 1141 and R fields 1142 in an octet.

Alternatively, if the length-indicator field is not needed (i.e. each control-type defines the exact message length), then in the PDCP-Control-PDU-1 1130 format the SN 1132 may be reduced to a 3-4 bit field and the control-type 1133 may be put in a 2-3 bit field. While for PDCP-Control-PDU-2 1140, padding may be put in the spaces of the length-indicator field 1144 if octet alignment is required.

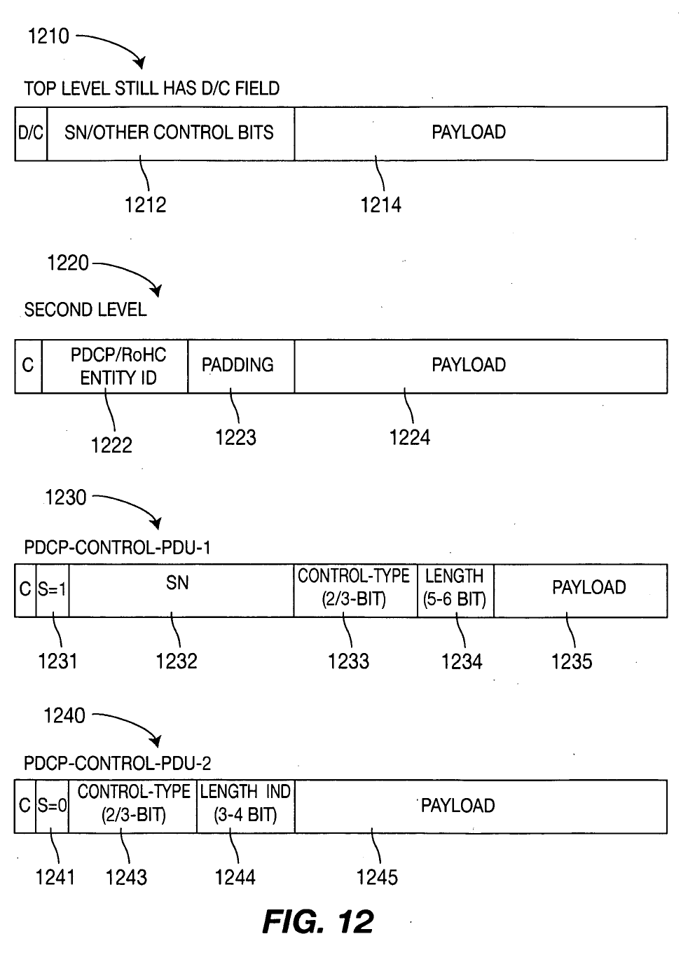

Another alternative for the PDCP-Control-PDU-1 1130 and the PDCP-Control-PDU-2 1140 is to have a 1-bit S field (e.g., after the R field 1111, 1121, 1131, and 1142 in FIG. 11), as shown in FIG. 12 at 1231 and 1241, indicating the presence of the SN field in the PDU header. If S has a value of one 1231, then the SN is present in the header and this is a PDCP-Control-PDU-1 (with the S field in addition to the FIG. 11 PDCP-Control-PDU-1). If the S has a value of zero 1241, then the SN is not present and this is a PDCP-Control-PDU-2 (with the S field in addition to the FIG. 11 PDCP-Control-PDU-2) with control-type or Length-indicator field length adjusted.

Independent RoHC Feedback channel and PDU Format

If a separate RoHC feedback channel in the U-plane is used for all RoHC feedback packets regardless of which RoHC entity, associated with a PDCP entity over a RB, a RoHC feedback packet is intended for, then the RoHC feedback packets are not multiplexing with U-plane data PDUs or PDCP-Control-PDUs. But, they are multiplexing with RoHC feedback packets of other PDCP or RoHC entities.

For the RoHC feedback packets that are not multiplexed, the R field 1111, 1121, 1131, and 1142 in FIG. 11 is not needed to distinguish the RoHC feedback packet from the PDCP-Control-PDU.

For the RoHC feedback that are multiplexed with RoHC feedback packets of other PDCP/RoHC entities on the PDCP receiving end a RoHC feedback preprocessor is needed to inspect the RoHC feedback packet to determine which PDCP or RoHC entity the feedback packet is intended for and distribute to the right PDCP or RoHC entity. Or, the PDU format for the RoHC feedback packet has to bear the intended PDCP or RoHC identity. For example, the PDCP or RoHC identity may be the logical channel ID, or the RB ID, or other types of identifications. The PDCP entity then, over the independent channel may determine via the ID to the right RoHC entity to distribute the feedback packet.

FIG. 12 shows RoHC feedback packet, which is carried in a separate logical channel or RB. If the presence of SN in PDCP-Control-PDU is not optional, then the PDCP-Control-PDU-1 1230 and PDCP-Control-PDU-2 1240 illustrated in FIG. 12, do not need the S field (as seen in Top Level, 1210). The SN/other control bit field 1212 and the payload fields 1214, 1224, 1235, and 1245 are the same as the one described above in FIG. 10. The second level (1220) does not have the R field because RoHC feedback has its own channel. For RoHC feedback packet, it may have the PDCP or the RoHC entity ID (1222). The other elements (i.e., SN 1232, padding 1223, control-type 1233 and 1243, length-ind 1234 and 1244, payload 1214, 1224, 1235, and 1245) are similar to those described in FIG. 11. The D/C field is also the same as those in FIG. 11.

PDCP Configuration and PDCP Reordering Function Activation

Each U-plane PDCP entity may be configured by the RRC at the RB at the time of establishment or reconfiguration to support either the seamless HO or the lossless HO.

The RB supporting lossless HO is preferably configured using RLC AM Transfer Mode (TM) and data-forwarding scheme, performed on the network side during the inter-eNB handover. In this case, the PDCP reordering function for HO is activated to provide the supported IS delivery of PDCP SDUs. The procedures and functions described above for the UL PDCP operation and the WTRU PDCP DL reordering function are applicable in this case.

The RB supporting seamless HO is preferably configured with RLC UM or RLC TM, and therefore, no data-forwarding in the network will be provided during an inter-eNB handover. In this case, there are few alternatives. The PDCP reordering function for seamless HO RB is inactive; or PDCP reordering function is activated during HO, but with more tolerable (i.e., longer) stale-prevention timer values and, optionally, larger reordering-range values.

In general, the PDCP function may depend on the RLC functionality. If the RLC IS delivery function is active, then the PDCP duplicate detection function may not be activated. If there is no RLC IS delivery, then the PDCP reordering may be activated.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A wireless/transmit receive unit (WTRU), the WTRU comprising:
a processing device configured such that a packet data convergence protocol (PDCP) entity processes a control plane data and a user plane data, wherein the PDCP entity further comprises:
a control plane (C-plane) entity that includes a PDCP sequence numbering entity, an integrity protection entity, and a control ciphering entity; and
a user plane (U-plane) entity that includes a robust header compression (RoHC) entity, a user ciphering entity, and an entity for a user plane data/control, wherein a format for a control plane PDCP protocol data unit (PDU) includes a PDCP sequence number, control plane data, and medium access control (MAC) information.

2. The WTRU as in claim 1, wherein the user plane PDCP entity is configured by a higher layer at a radio bearer establishment or reconfiguration time to support either a seamless handover or a lossless handover.

3. The WTRU as in claim 1, wherein the PDCP sequence numbering entity generates a PDCP sequence number (SN) that is placed in a message or a packet header.

4. The WTRU as in claim 1, wherein the user ciphering entity enhances data security.

5. The WTRU as in claim 1, wherein the user plane data/control entity is a multiplexing function that places a user plane data flow and peer-to-peer control packets together on a radio bearer.

6. The WTRU as in claim 1, wherein a format for the control plane PDCP protocol data unit (PDU) includes a sequence number (SN) bit field, an integrity protection (INT) bit, and a ciphering (CIP) bit.

7. The WTRU as in claim 6, wherein the SN bit field has a length of 6 bits.

8. The WTRU as in claim 7, wherein the INT bit and the CIP bit have a length of 1 bit.

9. The WTRU as in claim 1, wherein a format for the control plane PDCP protocol data unit (PDU) includes a sequence number (SN) bit field and a security protection (SEC) bit.

10. The WTRU as in claim 9, wherein the SEC bit indicates whether both integrity protection and ciphering have to be applied simultaneously.

11. The WTRU as in claim 9, wherein the SN bit field has a length of 7 bits.

12. The WTRU as in claim 1, wherein a format for the user plane PDCP protocol data unit (PDU) includes a header bit field for C or D.

13. The WTRU as in claim 12, wherein the header bit field C has a value of zero as C for PDCP control and RoHC feedback.

14. The WTRU as in claim 12, wherein the header bit field D has a value of one as D for regular data PDUS.

15. The WTRU as in claim 12, further comprising a second bit in the user plane PDCP control PDU that distinguishes between the PDCP control PDU and a RoHC feedback packet.

16. The WTRU as in claim 15, wherein the second bit is a reserved bit R.

17. The WTRU as in claim 16, wherein the reserved bit R has a value of zero for the PDCP control PDU.

18. The WTRU as in claim 16, wherein the reserved bit R has a value of one for the RoHC feedback packet.

19. A wireless/transmit receive unit (WTRU), the WTRU comprising:
a processing device configured such that a packet data convergence protocol (PDCP) entity processes a control plane data and a user plane data, wherein the PDCP entity further comprises:
a control plane (C-plane) entity that includes a PDCP sequence numbering entity, an integrity protection entity, and a control ciphering entity; and
a user plane (U-plane) entity that includes a robust header compression (RoHC) entity, a user ciphering entity, and an entity for a user plane data/control, and wherein a format for a user plane PDCP protocol data unit (PDU) includes a header bit field, a type field, and RoHC feedback, wherein the header bit field indicates whether the RoHC feedback PDU is data or control.

20. The WTRU as in claim 19, wherein the user plane PDCP entity is configured by a higher layer at a radio bearer establishment or reconfiguration time to support either a seamless handover or a lossless handover.

21. The WTRU as in claim 19, wherein the PDCP sequence numbering entity generates a PDCP sequence number (SN) that is placed in a message or a packet header.

22. The WTRU as in claim 19, wherein the RoHC is an internet protocol for header compression that reduces the total data volume.

23. The WTRU as in claim 19, wherein the user ciphering entity enhances data security.

24. The WTRU as in claim 19, wherein the user plane data/control entity is a multiplexing function that places a user plane data flow and peer-to-peer control packets together on a radio bearer.

25. The WTRU as in claim 19, wherein a format for the control plane PDCP protocol data unit (PDU) includes a sequence number (SN) bit field, an integrity protection (INT) bit, and ciphering (CIP) bit.

26. The WTRU as in claim 25, wherein the SN bit field has a length of 6 bits.

27. The WTRU as in claim 26, wherein the INT bit and the CIP bit have a length of 1 bit.

28. The WTRU as in claim 19, wherein a format for the control plane PDCP protocol data unit (PDU) includes a sequence number (SN) bit field and a security protection (SEC) bit.

29. The WTRU as in claim 28, wherein the SEC bit indicates whether both integrity protection and ciphering have to be applied simultaneously.

30. The WTRU as in claim 28, wherein the SN bit field has a length of 7 bits.

31. The WTRU as in claim 19, wherein a format for the user plane PDCP protocol data unit (PDU) includes a header bit field for C or D.

32. The WTRU as in claim 31, wherein the header bit field C has a value of zero to indicate PDCP control and RoHC feedback.

33. The WTRU as in claim 31, wherein the header bit field D has a value of one to indicate data PDUS.

34. The WTRU as in claim 31, further comprising a second bit in the user plane PDCP control PDU that distinguishes between the PDCP control PDU and a RoHC feedback packet.

35. The WTRU as in claim 34, wherein the second bit is a reserved bit R.

36. The WTRU as in claim 35, wherein the reserved bit R has a value of zero for the PDCP control PDU.

37. The WTRU as in claim 35, wherein the reserved bit R has a value of one for the RoHC feedback packet.

38. A wireless/transmit receive unit (WTRU), the WTRU comprising:
a processor, the processor is configured such that in response to receiving a higher layer handover command, a packet data convergence protocol (PDCP) entity determines a PDCP sequence number of a first missing PDCP service data unit (SDU); and
a transmitter, the transmitter configured to transmit the first missing PDCP SDU number.

39. The WTRU as in claim 38 wherein the first missing PDCP SDU number is transmitted in a PDCP status message.

40. The WTRU as in claim 39, wherein the processing device is configured such that in response to receiving the higher layer handover command, the PDCP entity deactivates PDCP reordering when all PDCP SDUs within a reordering window are delivered.

41. The WTRU as in claim 40, wherein the processing device is configured to apply PDCP reordering to data rate bearers (DRBs) mapped to radio link control acknowledge mode (RLC AM).

42. The WTRU as in claim 41, wherein the processing device is configured to apply PDCP reordering to DRBs mapped to RLC unconfirmed mode (RLC UM).

43. The WTRU as in claim 38, further comprising a user plane PDCP entity that is configured by a higher layer at a radio bearer establishment or reconfiguration time to support either a seamless handover or a lossless handover.

44. A method for activating a packet data convergence protocol (PDCP) reordering in a wireless transmit receive unit (WTRU), the method comprising:
receiving a handover command message;
resetting a radio link control (RLC) entity of the WTRU;
collecting a PDCP sequence number (SN) and a range of the SN of out-of-sequence service data units (SDUs);
reporting the PDCP SN to a radio resource control (RRC) layer of the WTRU;
transmitting a handover confirm message along with a first unacknowledged PDCP SN uplink (UL); and
activating the PDCP reordering based on the PDCP-SN-UL.

45. The method as in claim 44, further comprising transmitting PDCP status message along with base PDCP SN and a range for reordering.

46. The method as in claim 44, wherein the PDCP reordering is activated when the WTRU receives a first expected PDCP SN for reordering.

47. The method as in claim 44, wherein the PDCP reordering is activated when the WTRU receives a RRC handover command message that contains a flag.

48. The method as in claim 47, wherein the flag indicates least one of, activate PDCP reordering, reset RLC, reestablish RLC, reset RLC and MAC, reestablish RLC and MAC, reset layer 2, reestablish layer 2, and deactivate RLC reordering.

49. The method as in claim 44, wherein if the PDCP SN for the SDU is outside a reordering window in the lead edge, then the PDCP SN is stored.

50. The method as in claim 49, wherein the reordering window is not moved.

51. The method as in claim 44, wherein a timer value is set for RLC acknowledgement mode (AM) and the RLC AM notifies the PDCP reordering that all service data units (SDUs) have been received.

52. The method as in claim 51, wherein the timer for RLC AM is set to infinity.

53. The method as in claim 44, wherein the PDCP reordering function for handover is activated for delivering PDCP service data units (SDUs) in the uplink.

54. The method as in claim 44, wherein the PDCP reordering is activated from the RRC when the RRC handover command message is received along with a first expected PDCP SN.

55. The method as in claim 44, wherein the PDCP reordering is activated from the RLC before RLC reset or RLC reestablishment.

56. The method as in claim 44, wherein the PDCP reordering is activated when the RLC indicating a last in-sequence or first out-of-sequence RLC protocol data unit (PDU) or RLC service data unit (SDU) is delivered to the PDCP layer.

57. The method as in claim 44, wherein the transmitting the handover confirm message further comprises transmitting a PDCP status message along with the PDCP SN and the out of sequence PDCP SDUs.

58. Activating a packet data convergence protocol (PDCP) reordering in a wireless/transmit receive unit (WTRU), the WTRU comprising:
a receiver, the receiver configured to receive a handover command message;
a processor, the processor configured to reset a radio link control (RLC) entity of the WTRU, collect a PDCP sequence number (SN) and a range of the SN of out-of-sequence service data units (SDUs), reporting the PDCP SN to a radio resource control (RRC) layer of the WTRU, activate the PDCP reordering based on the PDCP-SN-UL; and
a transmitter, the transmitter configured to transmit a handover confirm message along with a first unacknowledged PDCP SN uplink (UL).

59. The method as in claim 58, further comprising the transmitter configured to transmit PDCP status message along with base PDCP SN and a range for reordering.

60. The method as in claim 58, wherein the PDCP reordering is activated when the WTRU receives a first expected PDCP SN for reordering.

61. The method as in claim 58, wherein the PDCP reordering is activated when the WTRU receives a RRC handover command message that contains a flag.

62. The method as in claim 61, wherein the flag indicates at least one of, activate PDCP reordering, reset RLC, reestablish RLC, reset RLC and MAC, reestablish RLC and MAC, reset layer 2, reestablish layer 2, or deactivate RLC reordering.

63. The method as in claim 58, wherein if the PDCP SN for the SDU is outside a reordering window in the lead edge, then the PDCP SN is stored.

64. The method as in claim 63, wherein the reordering window is not moved.

65. The method as in claim 58, wherein a timer value is set for RLC acknowledgement mode (AM) and the RLC AM notifies the PDCP reordering all service data units (SDUs) are received.

66. The method as in claim 65, wherein the timer for RLC AM is set to infinity.

67. The method as in claim 58, wherein the PDCP reordering function for handover is activated for delivering PDCP service data units (SDUs) in the uplink.

68. The method as in claim 58, wherein the PDCP reordering is activated from the RRC when the RRC handover command message is received along with a first expected PDCP SN.

69. The method as in claim 58, wherein the PDCP reordering is activated from the RLC before RLC reset or RLC reestablishment.

70. The method as in claim 58, wherein the PDCP reordering is activated when the RLC indicating a last in-sequence or first out-of-sequence RLC protocol data unit (PDU) or RLC service data unit (SDU) is delivered to the PDCP layer.

71. The method as in claim 58, wherein the transmitting the handover confirm message further comprises transmitting a PDCP status message along with the PDCP SN and the out of sequence PDCP SDUs.

72. A method for deactivating a packet data convergence protocol (PDCP) reordering in a wireless transmit receive unit (WTRU), the method comprising:
deactivating the PDCP reordering if all service data units (SDUs) in a reordering window have been delivered in-sequence.

73. The method as in claim 72, wherein the reordering window range is at least one of a parameter from a handover command, a last expected PDCP sequence number (SN) from handover command, and a predefined reordering range parameter for radio link control (RLC).

74. A wireless/transmit receive unit (WTRU) for deactivating a packet data convergence protocol (PDCP) reordering in a wireless transmit receive unit (WTRU), the WTRU comprising:
a processor configured to deactivate the PDCP reordering if all service data units (SDUs) in a reordering window have been delivered in-sequence.

75. The WTRU as in claim 74, wherein the reordering window range is at least one of a parameter from a handover command, a last expected PDCP sequence number (SN) from handover command, and a predefined reordering range parameter for radio link control (RLC).
